(19) United States
(12) Patent Application Publication
(10) Pub. No.: US 2023/0185307 A1
(43) Pub. Date: Jun. 15, 2023

(54) Device and Method for Planning Path of Robot

(71) Applicants: Hyundai Motor Company, Seoul (KR); Kia Corporation, Seoul (KR)

(72) Inventors: Jun Yeong Choi, Seoul (KR); Il Yong Yoon, Seoul (KR)

(21) Appl. No.: 17/811,932

(22) Filed: Jul. 12, 2022

(30) Foreign Application Priority Data
Dec. 14, 2021 (KR) 10-2021-0179077

(51) Int. Cl. G05D 1/02; G05D 1/00; H04N 5/232; H04N 5/225

(52) U.S. Cl. CPC G05D 1/0238; G05D 1/0094; G05D 1/0214; G05D 1/0246; H04N 5/23264; H04N 5/225251

(57) ABSTRACT

An embodiment device for planning a path of a robot includes a camera configured to capture an image in a moving direction of the robot and a controller configured to detect a moving obstacle in the image in the moving direction of the robot, to calculate a speed and a moving direction of the moving obstacle based on a change in a location of the moving obstacle, and to set a region of the moving obstacle based on the speed and the moving direction of the moving obstacle, the region being in a form of an ellipse.

### CROSS-REFERENCE TO RELATED APPLICATIONS

This application claims the benefit of Korean Patent Application No. 10-2021-0179077, filed on Dec. 14, 2021, which application is hereby incorporated herein by reference.

### TECHNICAL FIELD

The present disclosure relates to a device and a method for a planning path of a robot.

### BACKGROUND

In general, it is necessary to plan a path to a target point by avoiding a location of a fixed obstacle as well as a location of a moving obstacle for a holonomic robot to safely reach the target point. In this regard, when a degree of freedom of a movement of the robot satisfies a degree of freedom of a space in which the robot moves, this is referred to as holonomic. That is, when a robot moving in a plane has three degrees of freedom, the robot is referred to as the holonomic robot.

A conventional technology for planning the path of such a holonomic robot creates a map about a surrounding environment of the robot by exploring the surrounding environment of the robot, classifies an obstacle on the map as the fixed obstacle or the moving obstacle, and calculates the path of the robot based on a repulsion vector by the fixed obstacle, a repulsion vector by the moving obstacle, and an attraction vector by the target point.

Such prior art divides the entire plane into uniform compartments, defines each compartment as a cell, periodically determines whether the obstacle exists in each cell, and stores the determination result, thereby creating the map about the surrounding environment of the robot.

Therefore, the conventional technology is difficult to be applied to a low-spec robot that has a limitation in an amount of computation because it is necessary to calculate whether the cell is occupied by the obstacle one by one for all cells included in an obstacle region (including a surrounding region of the obstacle) on the grid map. In particular, as a speed of the moving obstacle increases, the obstacle region expands, and as a result, the number of cells that affect the amount of computation increases, so that the conventional technology is more difficult to be applied to the low-spec robot.

The matters described in this background section are written to promote understanding of the background of the invention and may include matters that are not already known to those of ordinary skill in the art to which this technology belongs.

### SUMMARY

The present disclosure relates to a device and a method for a planning path of a robot. Particular embodiments relate to a technology for quickly and accurately detecting an obstacle region (a fixed obstacle region and a moving obstacle region) in a process of planning a path of a holonomic robot.

Embodiments of the present disclosure can solve problems occurring in the prior art while advantages achieved by the prior art are maintained intact.

An embodiment of the present disclosure provides a device and a method for planning a path of a robot that may detect a moving obstacle in a camera image, calculate a speed and a moving direction of the moving obstacle based on a change in a location of the moving obstacle, set a region of the moving obstacle based on the speed and the moving direction of the moving obstacle in a form of an ellipse, and update outline information of the ellipse, thereby quickly and accurately detecting the region of the moving obstacle.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a device for planning a path of a robot includes a camera for capturing an image in a moving direction of the robot, and a controller that detects a moving obstacle in the image in the moving direction of the robot, calculates a speed and a moving direction of the moving obstacle based on a change in a location of the moving obstacle, and sets a region of the moving obstacle based on the speed and the moving direction of the moving obstacle in a form of an ellipse.

In one implementation, the controller may determine a shape of the ellipse and a direction of a long axis of the ellipse based on the speed and the moving direction of the moving obstacle.

In one implementation, the controller may plan the path of the robot by calculating whether an outline of the ellipse overlaps the path of the robot.

In one implementation, the camera may be an RGB-D camera.

In one implementation, the controller may control an actuator such that the camera captures the image in the moving direction of the robot.

In one implementation, the controller may stabilize the image in the moving direction of the robot captured by the camera using a Kalman filter.

According to another embodiment of the present disclosure, a method for planning a path of a robot includes capturing, by a camera, an image in a moving direction of the robot, detecting, by a controller, a moving obstacle in the image in the moving direction of the robot, calculating, by the controller, a speed and a moving direction of the moving obstacle based on a change in a location of the moving obstacle, and setting, by the controller, a region of the moving obstacle based on the speed and the moving direction of the moving obstacle in a form of an ellipse.

In one implementation, the setting of the region of the moving obstacle in the form of the ellipse may include determining a shape of the ellipse and a direction of a long axis of the ellipse based on the speed and the moving direction of the moving obstacle.

In one implementation, the method may further include planning, by the controller, the path of the robot by calculating whether an outline of the ellipse overlaps the path of the robot.

In one implementation, the capturing of the image in the moving direction of the robot may include rotating the camera to be directed in the moving direction of the robot.

In one implementation, the capturing of the image in the moving direction of the robot may include stabilizing the image in the moving direction of the robot captured by the camera using a Kalman filter.

In one implementation, the detecting of the moving obstacle in the image in the moving direction of the robot may include transmitting the image in the moving direction of the robot to a server, and receiving information about the moving obstacle in the image in the moving direction of the robot from the server.

According to another embodiment of the present disclosure, a device for planning a path of a robot includes a camera for capturing an image in a moving direction of the robot, and a controller that detects a moving obstacle in the image in the moving direction of the robot, calculates a speed and a moving direction of the moving obstacle based on a change in a location of the moving obstacle, and sets a region of the moving obstacle based on the speed and the moving direction of the moving obstacle in a form of a half ellipse.

In one implementation, the controller may determine a shape of the half ellipse and a direction of a long axis of the half ellipse based on the speed and the moving direction of the moving obstacle.

In one implementation, the controller may plan the path of the robot by calculating whether an outline of the half ellipse overlaps the path of the robot.

In one implementation, the controller may control an actuator such that the camera captures the image in the moving direction of the robot.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a block diagram for a path planning device of a robot according to an embodiment of the present disclosure;

FIG. 2 is an exemplary diagram showing a moving direction of a holonomic robot to which an embodiment of the present disclosure is applied;

FIG. 3 is an exemplary diagram showing a state in which a controller equipped in a path planning device of a robot according to an embodiment of the present disclosure expresses a moving obstacle region in a form of an ellipse;

FIG. 4 is a flowchart for a method for planning a path of a robot according to an embodiment of the present disclosure; and

FIG. 5 is a block diagram showing a computing system for executing a method for planning a path of a robot according to an embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiments of the present disclosure, a detailed description of the related known configuration or function will be omitted when it is determined that it interferes with the understanding of the embodiments of the present disclosure.

In describing the components of the embodiments according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

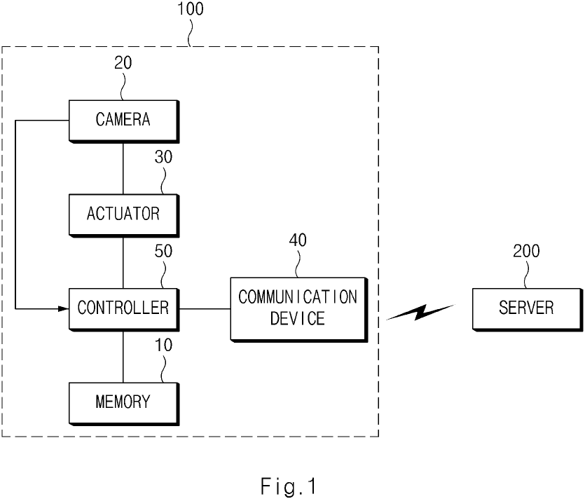

FIG. 1 is a block diagram for a path planning device of a robot according to an embodiment of the present disclosure.

As shown in FIG. 1, a path planning device 100 of a robot according to one embodiment of the present disclosure may be mounted on the robot, and may include a memory (i.e., a storage) 10, a camera 20, an actuator 30, a communication device 40, and a controller 50. In this regard, depending on a scheme of implementing the path planning device 100 of the robot according to one embodiment of the present disclosure, the components may be combined with each other and implemented as one component, or some components may be omitted.

Each of the components will be described. First, the memory 10 may store various logics, algorithms, and programs required in a process of detecting a moving obstacle in an image captured by the camera 20, calculating a speed and a moving direction of the moving obstacle based on a change in a location of the moving obstacle, setting a region of the moving obstacle based on the speed and the moving direction of the moving obstacle in a form of an ellipse, and updating outline information of the ellipse. In this regard, the ellipse may be, for example, a confidence ellipse, and such confidence ellipse may include a 95% confidence ellipse and a 99% confidence ellipse.

The memory 10 may store a deep learning-based moving obstacle recognition algorithm, which is used to detect the moving obstacle in the image captured by the camera 20.

The memory 10 may store an algorithm used to express the region of the moving obstacle as the ellipse (an equation of the ellipse) based on the speed and the moving direction of the moving obstacle.

The memory 10 may include at least one of recording media (storage media) such as a memory of a flash memory type, a hard disk type, a micro type, a card type (e.g., a secure digital card (SD card) or an extreme digital card (XD card)), and the like, and a memory of a random access memory (RAM) type, a static RAM (SRAM) type, a read-only memory (ROM) type, a programmable ROM (PROM) type, an electrically erasable PROM (EEPROM) type, a magnetic RAM (MRAM) type, a magnetic disk type, and an optical disk type.

The camera 20, which is a module for capturing a surrounding image of the robot, may include, for example, an RGB-D camera. Such RGB-D camera may simultaneously obtain depth information and color information of objects.

The actuator 30 may rotate the camera 20 in a moving direction of the robot under control of the controller 50. Therefore, the camera 20 may always capture an image in the moving direction of the robot even when the moving direction of the robot is changed.

The communication device 40, which is a module that provides an interface of communication with a server 200, may transmit the image captured by the camera 20 to the server 200, and may receive information about the moving obstacle in the image from the server 200. When the controller 50 is not able to recognize the moving obstacle in the image captured by the camera 20 by itself, the communication device 40 may transmit the image captured by the camera 20 to the server 200. In this regard, the server 200 may recognize the moving obstacle in the image using the deep learning-based moving obstacle recognition algorithm, and transmit the moving obstacle information (e.g., the location or the like) to the robot.

Such communication device 40 may include at least one of a mobile communication module, a wireless Internet module, and a short-range communication module.

The mobile communication module may communicate with the server 200 through a mobile communication network built based on technical standards or communication schemes for mobile communication (e.g., a global system for mobile communication (GSM), a code division multi access (CDMA), a code division multi access 2000 (CDMA2000), an enhanced voice-data optimized or enhanced voice-data only (EV-DO), a wideband CDMA (WCDMA), a high speed downlink packet access (HSDPA), a high speed uplink packet access (HSUPA), a long term evolution (LTE), a long term evolution-advanced (LTEA), and the like).

The wireless Internet module, which is a module for wireless Internet access, may communicate with the server 200 through a wireless LAN (WLAN), a wireless-fidelity (Wi-Fi), a wireless fidelity (Wi-Fi) Direct, a digital living network alliance (DLNA), a wireless broadband (WiBro), a world interoperability for microwave access (WiMAX), a high speed downlink packet access (HSDPA), a high speed uplink packet access (HSUPA), a long term evolution (LTE), a long term evolution-advanced (LTE-A), and the like.

The short-range communication module may support short-range communication with the server 200 using at least one of technologies of a Bluetooth™, a radio frequency identification (RFID), an infrared data association (IrDA), an ultra wideband (UWB), a ZigBee, a near field communication (NFC), and a wireless universal serial bus (Wireless USB).

The controller 50 may perform overall control such that each of the components may normally perform a function thereof. Such controller 50 may be implemented in a form of hardware, software, or a combination of the hardware and the software. Preferably, the controller 50 may be implemented as a microprocessor, but may not be limited thereto.

In particular, the controller 50 may perform various control in the process of detecting the moving obstacle in the image captured by the camera 20, calculating the speed and the moving direction of the moving obstacle based on the change in the location of the moving obstacle, setting the region of the moving obstacle based on the speed and the moving direction of the moving obstacle in the form of the ellipse, and updating the outline information of the ellipse.

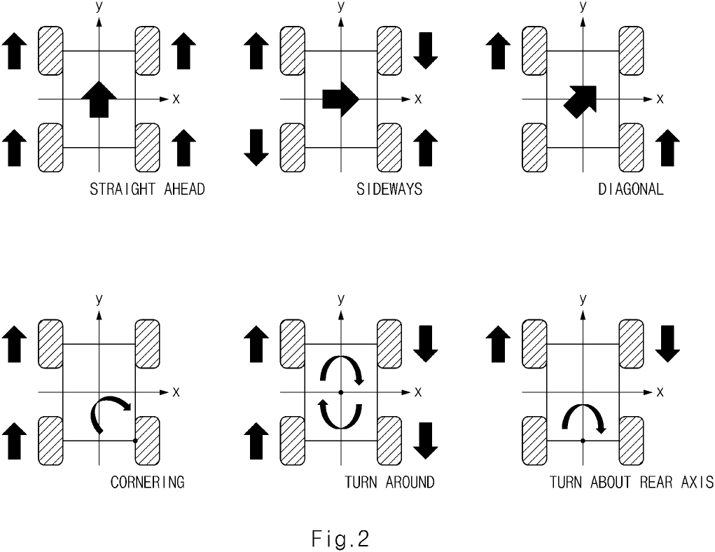

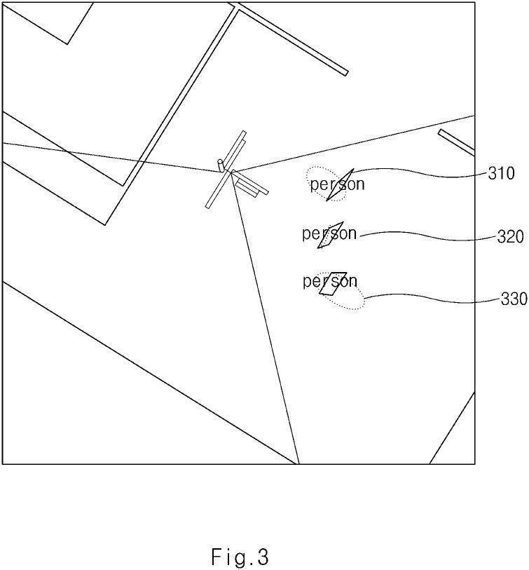

Hereinafter, an operation of the controller 50 will be described in detail with reference to FIGS. 2 to 3.

FIG. 2 is an exemplary diagram showing a moving direction of a holonomic robot to which an embodiment of the present disclosure is applied.

As shown in FIG. 2, the holonomic robot to which one embodiment of the present disclosure is applied may have a left front wheel, a right front wheel, a left rear wheel, and a right rear wheel to autonomously travel on a plane.

Such a robot may drive all of the left front wheel, the right front wheel, the left rear wheel, and the right rear wheel in a forward direction to go straight (straight ahead), may drive the left front wheel and the right rear wheel in the forward direction and drive the right front wheel and the left rear wheel in a reverse direction to move laterally (sideways), may drive the left front wheel and the right rear wheel in the forward direction to move in a diagonal direction, may drive the left front wheel and the left rear wheel in the forward direction to corner, may drive the left front wheel and the left rear wheel in the forward direction and drive the right front wheel and the right rear wheel in the reverse direction to turn around, or may drive the left front wheel in the forward direction and drive the right front wheel in the reverse direction to turn about a rear wheel axis.

FIG. 3 is an exemplary diagram showing a state in which a controller equipped in a path planning device of a robot according to an embodiment of the present disclosure expresses a moving obstacle region in a form of an ellipse.

As shown in FIG. 3, ‘310’ represents the moving obstacle, ‘320’ represents information of a label of the moving obstacle 310, and ‘330’ represents a region of the moving obstacle 310. In this regard, the label of the moving obstacle 310 is, for example, a person.

The controller 50 may detect the moving obstacle 310 from the image captured by the camera 20 using the deep learning-based moving obstacle recognition algorithm. That is, the controller 50 may detect the location of the obstacle in the image captured by the camera 20, and detect whether the obstacle is the moving obstacle or a fixed obstacle based on the change in the location of the obstacle. In this regard, because the depth information and the color information in the image captured by the RGB-D camera are not stable, the speed and the moving direction of the moving obstacle calculated based on the image may have poor accuracy, so that the controller 50 may use a Kalman filter algorithm to stabilize the image captured by the RGB-D camera.

In this regard, when the deep learning-based moving obstacle recognition algorithm is not equipped, or when the moving obstacle 310 is not able to be detected in the image captured by the camera 20 because the controller 50 is of low specification even though the deep learning-based moving obstacle recognition algorithm is equipped, the controller 50 may transmit the image captured by the camera 20 to the server 200 through the communication device 40, and may receive detection information of the moving obstacle 310 from the server 200.

In addition, the controller 50 may calculate the speed and the moving direction of the moving obstacle based on a change in a location of the moving obstacle 310.

In addition, the controller 50 may set the region of the moving obstacle 310 based on a speed and a moving direction of the moving obstacle 310 in the form of the ellipse. The region 330 of the moving obstacle set as such is as shown in FIG. 3. In this regard, a shape of the ellipse and a direction of a long axis of the ellipse may be determined by the speed and the moving direction of the moving obstacle 310.

For reference, the region of the ellipse is widened from one vertex of the long axis to a short axis, and the region gradually narrows toward the other vertex of the long axis. This is similar to a movement probability distribution of the moving obstacle. In other words, the moving obstacle has the smallest amount of location change at a current location, the amount of location change increases up to a certain distance in the moving direction as the moving obstacle is able to change the moving direction, and the amount of location change further increases at a distance exceeding the certain distance. However, when the distance exceeds the certain distance, the amount of location change may be considered small because it is a predicted location of the distant future. It may be seen that it is most appropriate to express such amount of location change of the moving obstacle as the ellipse.

In addition, without having to calculate whether all cells included in the moving obstacle region on a grid map are occupied by the moving obstacle one by one as in the prior art, the controller 50 only needs to calculate whether an outline of the ellipse (the equation of the ellipse) overlaps with a path of the robot, so that the path of the robot may be quickly and accurately planned.

In one example, the controller 50 may rotate the camera 20 through the actuator 30. That is, the controller 50 may control the actuator 30 such that the camera 20 is directed in the moving direction of the robot. In this regard, the controller 50 may detect the moving direction of the robot through a sensor (e.g., a gyro sensor).

In one embodiment of the present disclosure, the example of expressing the region 330 of the moving obstacle as the ellipse has been described. However, as another embodiment, the region 330 of the moving obstacle may be expressed as a half ellipse. In this regard, the half ellipse refers to a shape in which the ellipse is halved based on the short axis of the ellipse.

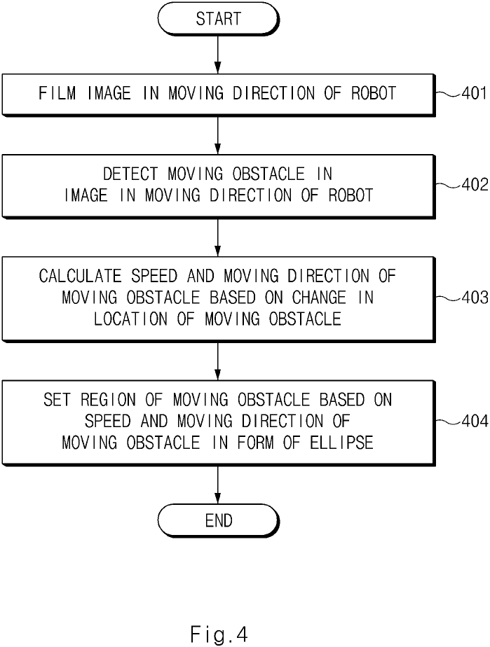

FIG. 4 is a flowchart for a method for planning a path of a robot according to an embodiment of the present disclosure.

First, the camera 20 captures the image in the moving direction of the robot (401).

Thereafter, the controller 50 detects the moving obstacle in the image in the moving direction of the robot (402).

Thereafter, the controller 50 calculates the speed and the moving direction of the moving obstacle based on the change in the location of the moving obstacle (403).

Thereafter, the controller 50 sets the region of the moving obstacle based on the speed and the moving direction of the moving obstacle in the form of the ellipse (404).

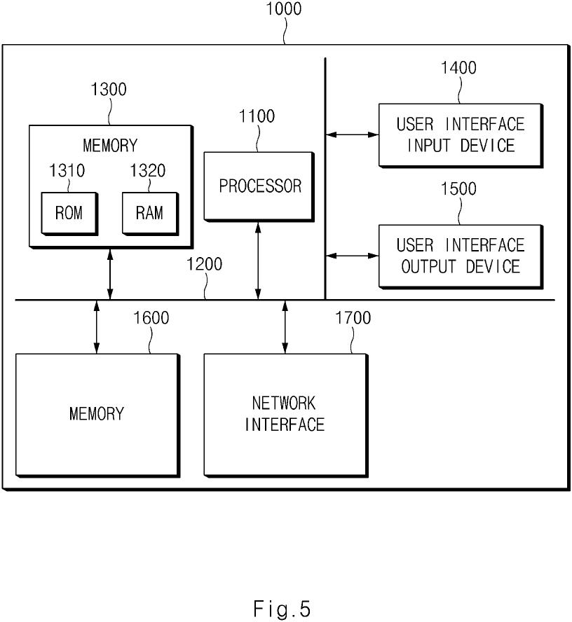

FIG. 5 is a block diagram showing a computing system for executing a method for planning a path of a robot according to an embodiment of the present disclosure.

Referring to FIG. 5, the method for planning the path of the robot according to one embodiment of the present disclosure described above may be implemented through a computing system. A computing system 1000 may include at least one processor 1100, a memory 1300, a user interface input device 1400, a user interface output device 1500, a memory (i.e., a storage) 1600, and a network interface 1700 connected via a system bus 1200.

The processor 1100 may be a central processing unit (CPU) or a semiconductor device that performs processing on commands stored in the memory 1300 and/or the memory 1600. The memory 1300 and the memory 1600 may include various types of volatile or nonvolatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the memory 1600) such as a RAM, a flash memory, a ROM, an EPROM, an EEPROM, a register, a hard disk, a solid state drive (SSD), a removable disk, and a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

The device and the method for planning the path of the robot according to one embodiment of the present disclosure as described above may detect the moving obstacle in the camera image, calculate the speed and the moving direction of the moving obstacle based on the change in the location of the moving obstacle, set the region of the moving obstacle based on the speed and the moving direction of the moving obstacle in the form of the ellipse, and update the outline information of the ellipse, thereby quickly and accurately detecting the region of the moving obstacle.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device for planning a path of a robot, the device comprising:
a camera configured to capture an image in a moving direction of the robot; and
a controller configured to:
detect a moving obstacle in the image in the moving direction of the robot;
calculate a speed and a moving direction of the moving obstacle based on a change in a location of the moving obstacle; and
set a region of the moving obstacle based on the speed and the moving direction of the moving obstacle, the region being in a form of an ellipse.

2. The device of claim 1, wherein the controller is configured to determine a shape of the ellipse and a direction of a long axis of the ellipse based on the speed and the moving direction of the moving obstacle.

3. The device of claim 1, wherein the controller is configured to plan the path of the robot by calculating whether an outline of the ellipse overlaps the path of the robot.

4. The device of claim 1, wherein the camera is an RGB-D camera.

5. The device of claim 1, further comprising an actuator configured to rotate the camera.

6. The device of claim 5, wherein the controller is configured to control the actuator such that the camera captures the image in the moving direction of the robot.

7. The device of claim 1, wherein the controller is configured to stabilize the image in the moving direction of the robot captured by the camera using a Kalman filter.

8. The device of claim 1, further comprising a communication device configured to:
transmit the image in the moving direction of the robot to a server; and
receive information about the moving obstacle in the image in the moving direction of the robot from the server.

9. A method for planning a path of a robot, the method comprising:
capturing an image in a moving direction of the robot;
detecting a moving obstacle in the image in the moving direction of the robot;
calculating a speed and a moving direction of the moving obstacle based on a change in a location of the moving obstacle; and
setting a region of the moving obstacle based on the speed and the moving direction of the moving obstacle, the region being in a form of an ellipse.

10. The method of claim 9, wherein setting the region of the moving obstacle comprises determining a shape of the ellipse and a direction of a long axis of the ellipse based on the speed and the moving direction of the moving obstacle.

11. The method of claim 9, further comprising calculating whether an outline of the ellipse overlaps the path of the robot.

12. The method of claim 9, wherein capturing the image is performed by an RGB-D camera.

13. The method of claim 9, wherein capturing the image in the moving direction of the robot comprises rotating a camera to be directed in the moving direction of the robot.

14. The method of claim 9, wherein capturing the image in the moving direction of the robot comprises stabilizing the image in the moving direction of the robot captured by a camera using a Kalman filter.

15. The method of claim 9, wherein detecting the moving obstacle in the image in the moving direction of the robot comprises:
transmitting the image in the moving direction of the robot to a server; and
receiving information about the moving obstacle in the image in the moving direction of the robot from the server.

16. A device for planning a path of a robot, the device comprising:
a camera configured to capture an image in a moving direction of the robot; and
a controller configured to:
detect a moving obstacle in the image in the moving direction of the robot;
calculate a speed and a moving direction of the moving obstacle based on a change in a location of the moving obstacle; and
set a region of the moving obstacle based on the speed and the moving direction of the moving obstacle, the region being in a form of a half ellipse.

17. The device of claim 16, wherein the controller is configured to determine a shape of the half ellipse and a direction of a long axis of the half ellipse based on the speed and the moving direction of the moving obstacle.

18. The device of claim 16, wherein the controller is configured to plan the path of the robot by calculating whether an outline of the half ellipse overlaps the path of the robot.

19. The device of claim 16, further comprising an actuator configured to rotate the camera.

20. The device of claim 19, wherein the controller is configured to control the actuator such that the camera captures the image in the moving direction of the robot.
